(19) United States
(12) Patent Application Publication
(10) Pub. No.: US 2025/0208311 A1
(43) Pub. Date: Jun. 26, 2025

(54) CHARACTERIZING AND MONITORING SUBSURFACE STIMULATED SERPENTINIZATION FOR GEOLOGIC HYDROGEN

(71) Applicant: Colorado School of Mines, Golden, CO (US)

(72) Inventors: Mengli Zhang, Golden, CO (US); Yaoguo Li, Golden, CO (US)

(21) Appl. No.: 18/987,154

(22) Filed: Dec. 19, 2024

Related U.S. Application Data
(60) Provisional application No. 63/613,054, filed on Dec. 20, 2023.

(51) Int. Cl. G01V 1/50; G01V 1/52

(52) U.S. Cl. CPC G01V 1/50; G01V 1/52; G01V 2210/163; G01V 2210/6161; G01V 2210/6222; G01V 2210/6224

(57) ABSTRACT

Embodiments disclosed herein describe methods and processes to perform dynamic imaging of naturally occurring or artificially stimulated serpentinization processes in subsurface rock units. The methods herein use a combination of electrical, electromagnetic, magnetic, and passive seismic data measured in and around the rock units undergoing the serpentinization process. Serpentinization is a chemical reaction between iron-rich minerals such as olivine and water under suitable temperature conditions, and the process naturally or artificially generates hydrogen gas that can be collected and used as a fuel. The serpentinization degree of the rock is an indicator of the potential hydrogen generation ability of the specific rock.

### CROSS-REFERENCE TO RELATED APPLICATION

The present application claims the benefit of priority to Provisional U.S. Patent Application No. 63/613,054 filed on Dec. 20, 2023, titled “Characterizing and Monitoring Subsurface Stimulated Serpentinization for Geologic Hydrogen,” which is incorporated herein by reference in its entirety.

### BACKGROUND

Serpentinization is a hydration and metamorphic transformation of ferromagnesian minerals, such as olivine and pyroxene, in mafic and ultramafic rock to produce serpentinite. In nature, serpentinite is created when water moves through mafic or ultramafic rocks, resulting in the production of serpentinite and molecular hydrogen (H₂).

### SUMMARY

Embodiments disclosed herein describe a method and system to perform dynamic imaging of a naturally occurring or an artificially stimulated serpentinization process in subsurface rock units. The method uses a combination of one or more of electrical, electromagnetic, magnetic, and seismic data measured in and around the rock units undergoing serpentinization process. Serpentinization is a chemical reaction between iron-rich minerals such as olivine and water under suitable temperature conditions and the process naturally or artificially generates hydrogen gas that can be collected and used as a fuel. The serpentinization degree of the rock is an indicator of the potential hydrogen generation ability of the specific rock as well as a factor to calculate the amount of H2 which has already been generated.

The measured data are processed to obtain three-dimensional (3D) distribution of physical properties, such as electrical conductivity, magnetic susceptibility and magnetization, and seismic velocity (i.e., speed of seismic wave propagation) and density as well as micro-seismic event locations within the volume of rock to be monitored.

Electrical conductivity, magnetic susceptibility, magnetization, and seismic velocity may be captured using geophysical inversion to construct a 3D function for the physical properties of the subsurface volume of rock to be examined. Techniques used include, but are not limited to, micro-seismic event location, a known technique for locating micro-seismic events, such as those induced by surface or subsurface stimulation.

The data are measured using respective transmitters and sensors commonly available in geophysics. The physical properties in the 3D volume obtained from the measured geophysical data are then combined to form images of the spatial extent and degree of serpentinization in the rocks. Combining the images may be performed by mapping the values of the different physical properties into an identification of whether a piece of rock in the subsurface is serpentinized or how much it has been serpentinized. Because different degrees of serpentinization have known ranges of different physical property values (e.g., conductivity, susceptibility, velocity, etc.), which forms the relationship between the constructed properties and the serpentinization degree the 3D volume being monitored. This relationship enables the prediction of the 3D distribution of serpentinization degree from the measured data.

Methods of predicting the different geologic units using derived physical properties in the static mode have been published for imaging naturally occurring geology and mineralization, but such methods have not been applied to imaging and monitoring dynamic processes such as stimulated serpentinization with physical property changes over time. One preferred method for efficiently collecting geophysical data used to derive physical properties comprises ergodic sampling.

The described methods and processes use the combination of geophysical data collection and processing tools to perform time-lapse monitoring (i.e., repeated imaging) of the dynamic process of serpentinization that occurs in rocks due to natural occurrence or artificial stimulation for hydrogen generation. The interval for repeated measurements is variable. For example, the interval for stimulation may occur over the course of an hour, which is sufficient time for the stimulation, or over the course of a week or longer. For natural occurrences, the interval may need to be performed over several weeks or months.

Geologic hydrogen has the potential to transform the clean energy supplies as a primary energy source. One of the major generation mechanisms of geologic hydrogen is the stimulated serpentinization process, which generates hydrogen which may be used for producing clean energy from injecting water and a catalyst to induce and stimulate hydrogen generation in ultramafic rocks existing widely in the earth's crust. This process has had success in laboratories; however, transferring laboratory results to a field geological setting is a significant challenge since there is no equivalent of laboratory equipment and machines to monitor the field stimulation in-situ directly. The field sizes are on kilometer scales and involve a complicated geological setting rather than the millimeter-scale of samples in the laboratory environment.

Systems and methods of the present disclosure for characterizing and monitoring subsurface stimulated serpentinization processes using geophysical methods can ensure the transfer of laboratory study results on stimulated serpentinization lab processes to field sites. Methods include setting up sensors in the field (hardware), taking measured data repeatedly over some interval (hardware), processing the data (software), reconstruction of the physical properties (algorithm and software), and combining the constructed (inverted) physical properties to predict the serpentinization.

Embodiments utilize efficient geophysical data collection, processing the collected data, imaging serpentinization, and feedback. Feedback may be provided to engineering control for subsequent data collection and repeating one or more of the foregoing steps. Next, 3D physical properties are obtained separately for each data set-property pair (individual inversion) and/or by joint inversion. Joint inversion is the process of jointly working with two or more data sets (e.g., magnetic and electromagnetic) to simultaneously construct susceptibility and conductivity models. Physical properties constructed through individual or joint inversion are used to delineate locations of serpentinization, volume, and degree of the serpentinization within geologic formation such as ultramafic rocks.

The imaged serpentinization locations and degree of serpentinization derived from the geophysical data will then be used to guide the operation of water and catalyst injection as well as the real-time decision-making on the stimulation process. The key parameters for stimulated geologic hydrogen engineering include: how fast and how much water to inject, how much catalyst to add, where in the ground and through which wells should more or less water/catalyst be injected, what pressure to use. These parameters can be adjusted based on the serpentinization imaged as described herein.

The stimulation process can occur fast and lead to changes over a hourly for artificial simulation under optimal condition and weekly for enhanced natural occurrences. On-site engineers can verify the resulting analysis and correlate expected results to actual results. For source rocks to generate hydrogen, injection rates and pressures must not bypass the local pieces of rock, otherwise serpentinization will not occur and hydrogen will not be produced. Therefore, this geophysical monitoring technology is a significant and necessary component for the resource development of the stimulated hydrogen.

In some aspects, the techniques described herein relate to a method, including performing dynamic imaging of an artificially stimulated serpentinization process in a subsurface rock unit.

In some aspects, the techniques described herein relate to a method, further including: obtaining measured data from the dynamic imaging; and determining from the measured data at least one of electrical conductivity, magnetic susceptibility and magnetization, seismic velocity, and micro-seismic event locations within the subsurface rock unit.

In some aspects, the techniques described herein relate to a method, further including: generating a three-dimensional image of the subsurface rock unit from a combination of two or more of electrical conductivity, magnetic susceptibility and magnetization, seismic velocity, and micro-seismic event locations.

In some aspects, the techniques described herein relate to a method, including: imaging a volume of rock in a subsurface region; obtaining measured data from imaging; determining from the measured data at least two physical aspects including: (1) electrical conductivity; (2) magnetic susceptibility and magnetization; (3) seismic velocity and seismic density; and (4) micro-seismic event locations a volume of rock; determining an area of serpentinization within the volume of rock including generating a model of the volume of rock by combining the at least two physical aspects; and directing hydrogen capturing equipment to collect and extract hydrogen from at least one of the area of serpentinization or other areas with hydrogen accumulation.

In some aspects, the techniques described herein relate to a method, wherein directing the hydrogen capturing equipment in accordance with the area of serpentinization further includes: identifying a feature in the volume of rock that concentrates hydrogen; and directing the hydrogen capturing equipment to the feature.

In some aspects, the techniques described herein relate to a method, further including identifying a fault structure in the area of serpentinization based on the model generated by combining the at least two physical aspects.

In some aspects, the techniques described herein relate to a method, wherein generating the model further includes generating a three-dimensional image of the volume of rock including the at least two physical aspects.

In some aspects, the techniques described herein relate to a method, wherein the area of serpentinization is at least one of artificially stimulated or naturally occurring.

In some aspects, the techniques described herein relate to a method, wherein imaging the volume of rock further includes: deploying a number of transmitters to transmit a corresponding number of signals through the volume of rock; deploying a number of receivers to receive the number of signals; activating at least some of the number of transmitters; and receiving, at the number of receivers, at least a portion of the number of signals and converting the portion of the number of signals into image data.

In some aspects, the techniques described herein relate to a method, wherein the number of transmitters and the number of receivers form at least one of a surface sensor array, a cross-well sensor array, and a combined surface-borehole sensor array.

In some aspects, the techniques described herein relate to a method, identifying a fault structure or network of fractures that occur naturally or are produced artifactually in the area of serpentinization based on the model generated by combining the at least two physical aspects, the fault structure concentrating hydrogen, wherein: directing the hydrogen capturing equipment in accordance with the area of serpentinization further includes directing the hydrogen capturing equipment to the fault structure; generating the model further includes generating a three-dimensional image of the volume of rock including the at least two physical aspects; and the area of serpentinization is at least one of artificially stimulated or naturally occurring; imaging the volume of rock further includes: deploying a number of transmitters to transmit a corresponding number of signals through the volume of rock; deploying a number of receivers to receive the number of signals; activating the number of transmitters; receiving, at the number of receivers, at least a portion of the number of signals and converting the portion of the number of signals into image data; the number of transmitters and the number of receivers form at least one of a surface sensor array, a cross-well sensor array, and a combined surface-borehole sensor array; and the number of receivers utilizes one or more of: ergodic sampling or regular sampling.

In some aspects, the techniques described herein relate to a system for extracting hydrogen from a volume of rock in a subsurface region, including: a control system, the control system including at least one processor coupled to a computer memory having instructions stored therein that, when read by the at least one processor, cause the at least one processor to perform: imaging a volume of rock in a subsurface region; obtaining measured data for imaging; determining from the measured data at least two physical aspects including: (1) electrical conductivity; (2) magnetic susceptibility and magnetization; (3) seismic velocity and seismic density; and (4) micro-seismic event locations a volume of rock; determining an area of serpentinization within the volume of rock including generating a model of the volume of rock by combining the at least two physical aspects; and directing hydrogen capturing equipment to collect and extract hydrogen from at least one of the area of serpentinization or other areas with hydrogen accumulation.

In some aspects, the techniques described herein relate to a system, wherein directing the hydrogen capturing equipment in accordance with the area of serpentinization further includes: identifying a feature in the volume of rock that concentrates hydrogen; and directing the hydrogen capturing equipment to the feature.

In some aspects, the techniques described herein relate to a system, further including identifying a fault structure in the area of serpentinization based on the model generated by combining the at least two physical aspects.

In some aspects, the techniques described herein relate to a system, wherein generating the model further includes generating a three-dimensional image of the volume of rock including the at least two physical aspects.

In some aspects, the techniques described herein relate to a system, wherein the area of serpentinization is at least one of artificially stimulated or naturally occurring.

In some aspects, the techniques described herein relate to a system, wherein imaging the volume of rock further includes: deploying a number of transmitters to transmit a corresponding number of signals through the volume of rock; deploying a number of receivers to receive the number of signals; activating at least some of the number of transmitters; and receiving, at the number of receivers, at least a portion of the number of signals and converting the portion of the number of signals into image data.

In some aspects, the techniques described herein relate to a system, wherein the number of transmitters and the number of receivers form at least one of a surface sensor array, a cross-well sensor array, and a combined surface-borehole sensor array.

In some aspects, the techniques described herein relate to a system, wherein directing the hydrogen capturing equipment includes forming an injection well that extends from the surface to an area of the volume of rock including the area of serpentinization and wherein: the control system is connected to one or more of a valve associated with the injection well; the instructions further cause the at least one processor to regulate at least one of flow rate and pressure of a fluid, the fluid including water and a catalyst; and the injection well injects the fluid into the area of the volume of rock including the area of serpentinization.

In some aspects, the techniques described herein relate to a system, wherein the hydrogen capturing equipment includes a hydrogen extraction well extending from the surface to the area of serpentinization.

In some aspects, the techniques described herein relate to a system, wherein the hydrogen capturing equipment includes a hydrogen extraction well located at a feature in the volume of rock that concentrates hydrogen produced in the area of serpentinization.

In some aspects, the techniques described herein relate to a system, identifying a fault structure in the area of serpentinization based on the model generated by combining the at least two physical aspects, the fault structure concentrating hydrogen, wherein: directing the hydrogen capturing equipment in accordance with the area of serpentinization further includes directing the hydrogen capturing equipment to the fault structure; generating the model further includes generating a three-dimensional image of the volume of rock including the at least two physical aspects; the area of serpentinization is at least one of artificially stimulated or naturally occurring; imaging the volume of rock further includes: deploying a number of transmitters to transmit a corresponding number of signals through the volume of rock; deploying a number of receivers to receive the number of signals; activating the number of transmitters; and receiving, at the number of receivers, at least a portion of the number of signals and converting the portion of the number of signals into image data; the number of transmitters and the number of receivers form at least one of a surface sensor array, a cross-well sensor array, and a combined surface-borehole sensor array; and the number of receivers utilizes one or more of: ergodic sampling or regular sampling.

In some aspects, the techniques described herein relate to a control system, including: at least one processor coupled to a computer memory having instructions stored therein that, when read by the at least one processor, cause the at least one processor to perform: imaging a volume of rock in a subsurface region; obtaining measured data from the imaging; determining from the measured data at least two physical aspects including: (1) electrical conductivity; (2) magnetic susceptibility and magnetization; (3) seismic velocity and seismic density; and (4) micro-seismic event locations a volume of rock; determining an area of serpentinization within the volume of rock including generating a model of the volume of rock by combining the at least two physical aspects; and directing hydrogen capturing equipment to collect and extract hydrogen from at least one of the area of serpentinization or other areas with hydrogen accumulation.

A system on a chip (SoC) including any one or more of the above aspects or embodiments of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts survey designs in accordance with embodiments of the present disclosure;

FIG. 3 depicts a workflow in accordance with embodiments of the present disclosure;

FIG. 4 depicts a workflow in accordance with embodiments of the present disclosure;

FIG. 5 depicts an integration of multiple geophysical inversion models in accordance with embodiments of the present disclosure;

FIG. 6 depicts a workflow in accordance with embodiments of the present disclosure;

FIG. 7 depicts a process in accordance with embodiments of the present disclosure; and

FIG. 8 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

### Problem Statement:

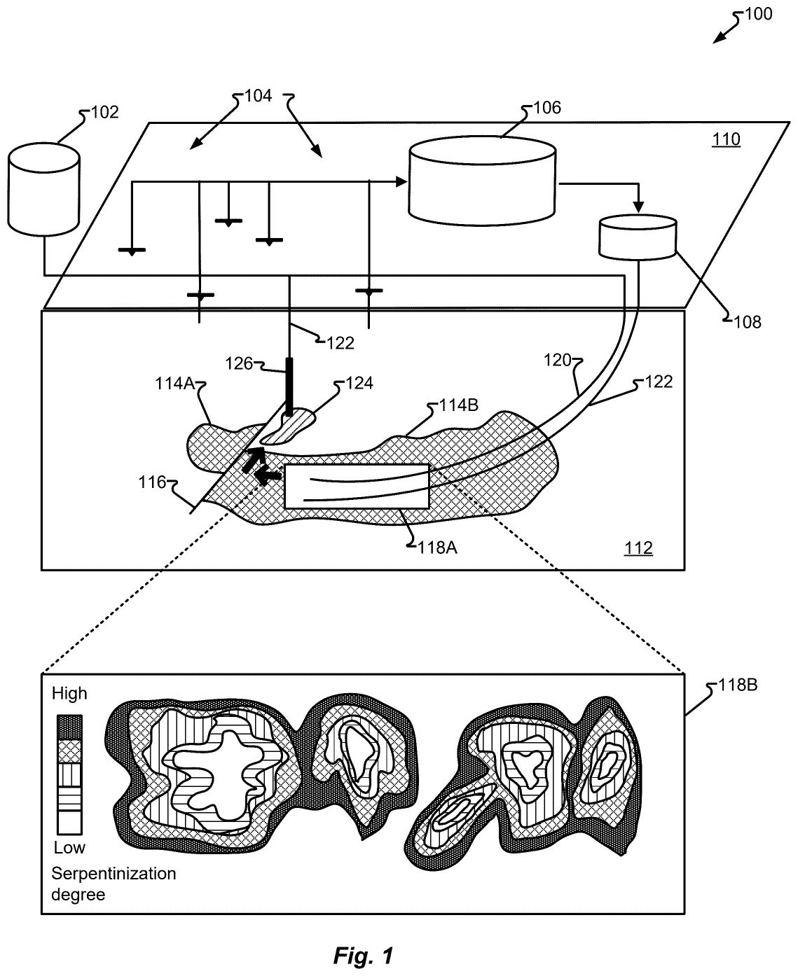

FIG. 1 depicts system 100 in accordance with embodiments of the present disclosure. In one embodiment, system 100 depicts a geophysical characterizing subsurface serpentinization zone and degree, and geophysical monitoring on geologic hydrogen generation and extraction.

Clean energy is urgently needed in the ongoing energy transition, and stimulated geologic H₂ is one of the promising solutions. The rocks that can potentially generate geologic hydrogen (H₂) are widely distributed in the earth's crust, and there is potential and also laboratory successes in stimulating these rocks to generate hydrogen. However, there is no technology specifically developed for characterizing such source rocks and monitoring the stimulation process for the purpose of H₂ resource development. There is a pressing need for monitoring H₂ production through stimulation. Meanwhile, the cost and time required to collect geophysical data is also an obstacle that slows down the process and prolongs the development cycle, which will likely also impede the willingness of energy industries to engage in geologic H₂ exploration. Prior art research has developed efficient and economical data acquisition technology as an enabler for monitoring stimulated and geologic H₂. The method of the embodiments of the present disclosure combines efficient data collection with multiple geophysical methods to form a near real-time monitoring method for stimulated geologic hydrogen generation.

In one embodiment, geophysical monitoring center 106 provides control inputs to water-catalyst storage 108 for injection into subsurface region 112, such as a fluid injection wherein the fluid comprises water and a catalyst to promote hydrogen production. Injection line 122 may be inserted into an existing borehole (not shown) or drilled separately into serpentinization zone 118, shown as serpentinization zone 118A in subsurface region 112 and as detailed in serpentinization zone 118B (enlarged and showing concentration details). Target area 114 comprises target area 114A and target area 114B separated by fault structure 116. Water and/or a catalyst is inserted into serpentinization zone 118B via injection line 122, producing geologic hydrogen. The hydrogen is collected via extraction line(s) 120, such as to receive hydrogen from extraction well 126 targeting areas of hydrogen accumulation such as hydrogen concentration 124, and/or directly from serpentinization zone 118A.

In another embodiment, surface area 110 may be deployed with hydrogen storage 102 for collection of extracted hydrogen and one or more geophysical transmitters 104.

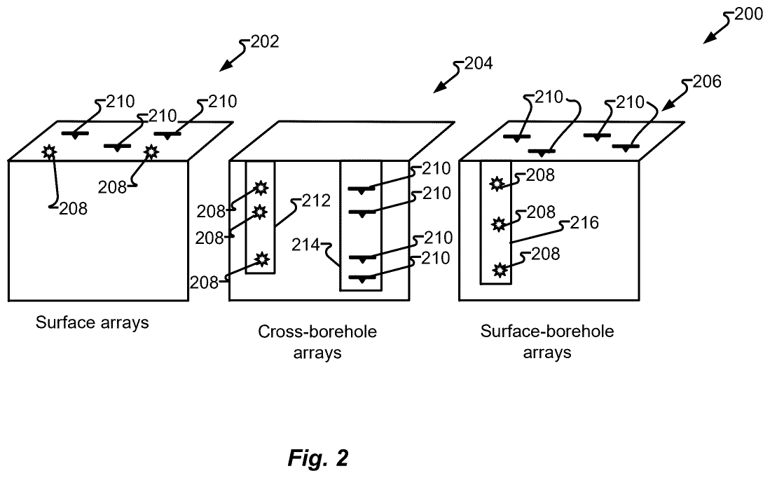

FIG. 2 depicts survey designs 200 in accordance with embodiments of the present disclosure. Imaging may comprise one or more of electrical, electromagnetic, magnetic, and active or passive seismic observations. In one embodiment, survey design 202 illustrates a number of transmitters 208 and a number of receivers 210 deployed on a surface to perform subsurface imaging. The number of transmitters 208 provide signal(s) that are produced and/or diffused and/or refracted and/or reflected from subsurface features and received by the number of receivers 210. One benefit of survey design 202 is the relatively low cost of installation using ergodic sampling as the number of transmitters 208 and the number of receivers 210 are applied to the surface.

In another embodiment, survey design 204 comprises the number of transmitters 208 arranged along the depth of borehole 212 and the number of receivers 210 arranged along the depth of borehole 214. Signals are then generated by the number of transmitters 208 and received, as modified by subsurface features, by the number of receivers 210.

In another embodiment, survey design 206 comprises the number of transmitters 208 arranged along the depth of borehole 216 and the number of receivers 210 arranged along the surface. Signals are then generated by the number of transmitters 208 and received, as modified by subsurface features, by the number of receivers 210.

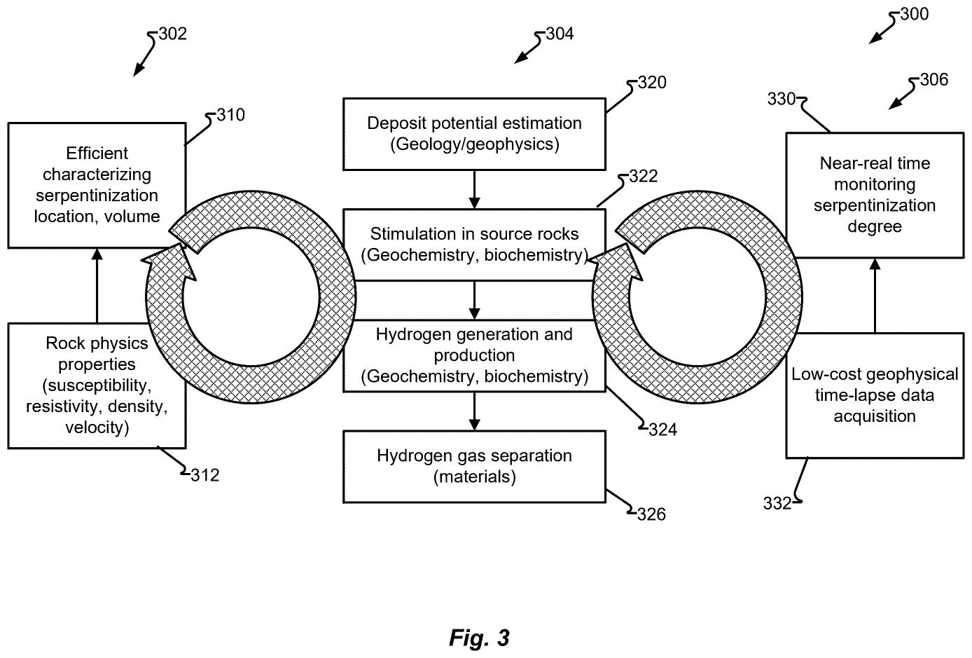

FIG. 3 depicts workflow 300 in accordance with embodiments of the present disclosure. In one embodiment, workflow 300 illustrates a workflow for monitoring a stimulated hydrogen process and extraction with geophysical methods. Column 304 generally illustrates the entire process of stimulating and extracting hydrogen. Geophysical characterization is depicted in column 302 and monitoring is depicted in column 306.

Block 310 illustrates efficient characterizing serpentinization location and/or volume. Block 312 illustrates a volume of rock's physical properties (e.g., susceptibility, resistivity, and/or density). Block 320 illustrates deposit potential estimation (e.g., geology and/or geophysics). Block 322 illustrates stimulation in the source volume of rock (e.g., geochemistry and/or biochemistry). Block 324 illustrates hydrogen generation and production (e.g., geochemistry and/or biochemistry). Block 326 illustrates hydrogen gas separation (e.g., materials). Block 330 illustrates near-real time monitoring of the serpentinization zone and the degree of serpentinization.

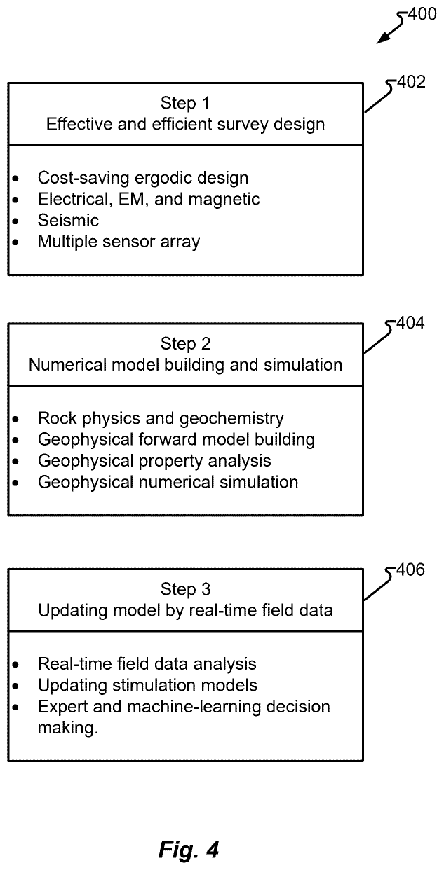

FIG. 4 depicts workflow 400 in accordance with embodiments of the present disclosure. In one embodiment, workflow 400 illustrates a geophysical workflow for characterizing and monitoring serpentinization and hydrogen generation.

Block 402 illustrates step 1, comprising an efficient survey design. Block 402 may utilize a cost-saving ergodic design for electrical, electromagnetic (EM), and magnetic surveys. Active and passive seismic sensing may also be utilized. Block 402 may utilize multiple sensor arrays. Block 404 illustrates step 2 comprising numerical model building and simulation. Block 404 may utilize rock physics and geochemistry, geophysical forwarding model building, geophysical property analysis, and/or geophysical numerical simulation. Block 406 illustrates step 3, comprising updating the model by real-time field data. Block 406 may comprise real-time field data analysis, updating stimulation models, and expert and machine-learning decision making. As a result, areas of serpentinization are identified, optionally artificially stimulated, and hydrogen extraction equipment, such as hydrogen stimulation and/or borehole directed to areas of hydrogen concentration.

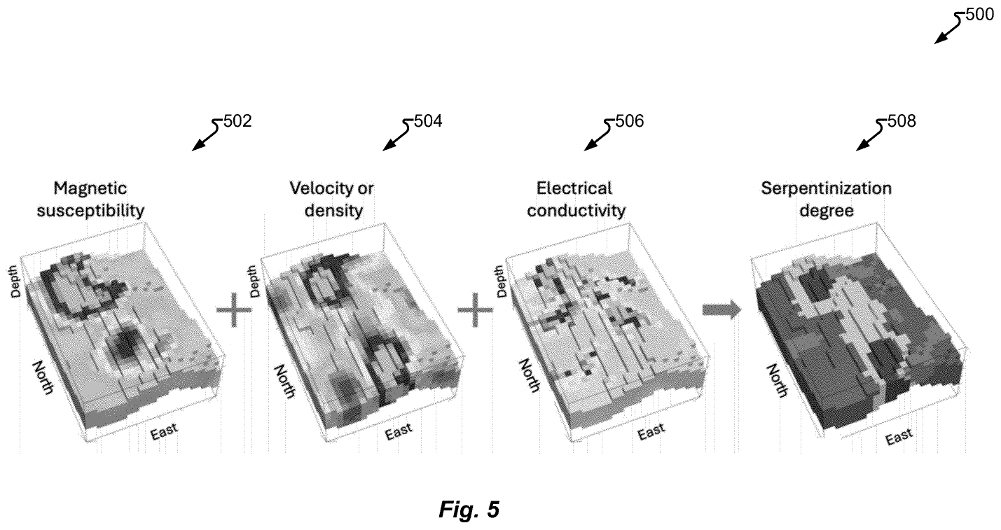

FIG. 5 depicts integration 500 of multiple geophysical inversion models in accordance with embodiments of the present disclosure. In one embodiment, integration 500 illustrates integrating multiple geophysical inversion models to image serpentinization in a 3D volume. One or more of magnetic susceptibility panel 502, velocity or density panel 504, and electrical conductivity panel 506 are combined to form serpentinization panel 508. Small subvolumes in panels 502, 504, and 506 are known as cells or voxels (based on the data resolution) of geophysical images of susceptibility, density, and electrical conductivity models from 3D inversions. Serpentinization panel 508 is a quasi-geology model derived from the geophysical models that produce magnetic susceptibility panel 502, velocity or density panel 504, and electrical conductivity panel 506.

Geologic hydrogen (H₂) as a low-carbon potential energy resource can be readily introduced into the existing energy supply and will reduce current energy-related emissions and reduce energy imports. The developed transformative technology described in the present disclosure provides the tools to monitor stimulated H₂ generation and extraction using economic geophysical data collection and integrated geophysical imaging. The innovations of the workflow of the present disclosure lie in the integrated geophysical approach to identifying and imaging serpentinization for stimulated hydrogen resource development and for doing so with potentially disruptive efficiency. The benefits of the systems and methods of embodiments of the present disclosure lies in its ability to address a critical component of H₂ resource development, namely, monitoring generation and production of stimulated H₂. Workflow 300 (see FIG. 3), and specifically column 304, generally illustrates the entire process of stimulating and extracting hydrogen.

There are three different types of geophysical survey arrays depicted in survey designs 200 (see FIG. 2). Survey designs 200 illustrate embodiments of effective and efficient survey designs using cost- and time-saving sampling theory, which may comprise one or more of ergodic sampling, including surface sensor arrays (illustrated in survey design 202), cross-well (also known as cross-borehole) arrays (illustrated in survey design 204), and combined surface-borehole arrays (illustrated in survey design 206).

Integration of electromagnetic and magnetic data is effective in delineating ultramafic H₂ source rocks such as ultramafic, mafic, and other Fe (II)-rich rocks. Integration comprises the steps of processing the data sets, constructing 3D functions of the physical properties, and combining them (described above) to form a 3D image of serpentinization at the time instances the data were measured.

Ultramafic rocks have distinct ranges of physical property values (e.g., magnetic susceptibility, electrical conductivity, etc.), which enables geophysics to image these rocks. However, a single geophysical data set is insufficient, and integration of multiple geophysical methods is required. Integration 500 (see FIG. 5) illustrates the concept using an analogous mineral exploration example, in which each of the three inverted physical properties only provides a partial description of the geology hosting a shallow serpentinization for hydrogen generation, but the classification (i.e., the quasi-geology model) using the three physical property models is able to identify the serpentinization zones. Ultramafic delineation technology uses the conductivity from electrical and electromagnetic (EM) data, susceptibility from magnetic data, and velocity from seismic data. Electrical, EM, and magnetic data are chosen for their established large depths of investigation in addition to their sensitivities to the electrical conductivity and magnetic susceptibility of ultramafic rocks and for their versatility in field deployment. Seismic data are chosen for their high resolution and sensitivity to lithologic boundaries.

The developed technology consists of two stages. The first stage relies on individual inversions of electromagnetic, magnetic, and seismic data, which will incorporate geologic priori information, such as depth, structural, and physical property knowledge, such as by using known techniques. Next, these physical properties (magnetic susceptibility or magnetization, electrical conductivity, and velocity) are integrated through expert work or unsupervised machine learning, or more specifically, data classification or clustering analysis, to identify the presence of ultramafics and delineate their spatial extents and volumes. This component is essentially a recombination and reconfiguration of existing technological components to produce an early-win new technology that meets the needs of H₂ resource development. The second stage consists of a joint inversion method for these data sets by coupling the conductivity, susceptibility, and/or velocity through data classification methods, such as fuzzy c-means clustering. It will also incorporate the previously mentioned prior geologic information. The joint inversion will make use of the known combinations of conductivity, susceptibility, and velocity for ultramafics as well as for serpentinized zones within. This stage of the technology improves the definition of ultramafics against other geologic units that may have similar ranges of conductivity or susceptibility. The technology can image the serpentinization zones inside the ultramafic rocks. These capabilities will be valuable in providing more detailed characterization of source rocks.

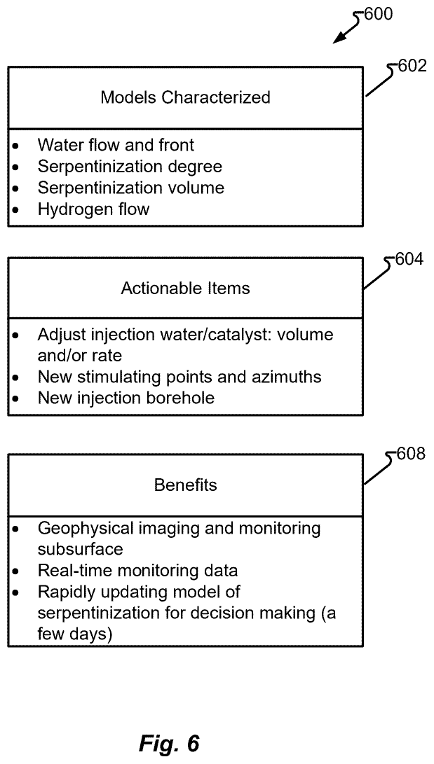

FIG. 6 depicts workflow 600 in accordance with embodiments of the present disclosure. In one embodiment, the goal of the technology is to ensure successful stimulated H₂ generation processing and decision making. Block 602 illustrates examples of models characterized. The models may comprise one or more of water pattern and front, serpentinization degree, serpentinization volume, and hydrogen flow. Block 604 illustrates actionable results, such as may be performed in response to the models characterized in block 602. Actionable items may comprise one or more of an adjustment to the water/catalyst volume or rate, new stimulation points and azimuths, new injection boreholes. Bock 608 illustrates benefits realized from the actionable items in block 604. Benefits may include one or more of imaging and monitoring of subsurface geophysical attributes, real-time monitoring, and rapidly updating models of serpentinization for decision making (which may take a few days).

This technology can build different models for stimulated hydrogen generation, obtain actionable information for decision making, and enhance the stimulated H₂ generation and production, ensuring the growth of the stimulation H₂ industry. Meanwhile, this technology can help test related upstream and downstream businesses such as H₂ catalysts and gas separation and extraction equipment manufacturers.

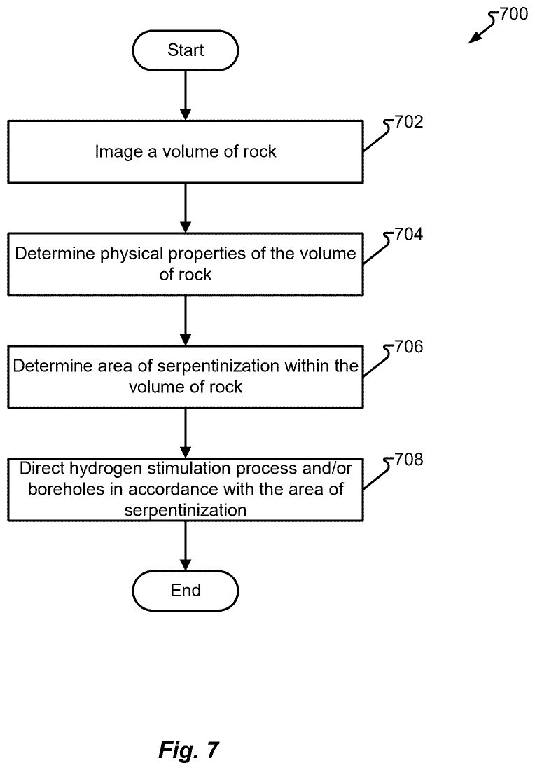

FIG. 7 depicts process 700 in accordance with embodiments of the present disclosure. In one embodiment, process 700 is embodied, in whole or in part, as machine-readable instructions maintained in a non-transitory computer memory and, when read by one or more processors, cause the one or more processors to execute the steps of process 700. Process 700 may comprise the one or more processors interacting with imaging equipment (e.g., number of receivers 210), transmitters (e.g., number of transmitters 208), extraction equipment (e.g., extraction well 126, extraction line(s) 120, and injection well 126), etc. Additionally or alternatively, geophysical monitoring center 106 may comprise the one more or more processors executing process 700.

Process 700 begins and, in step 702, a volume of rock is imaged. The volume of rock comprises a three-dimensional subsurface portion of Earth. Step 702 may comprise one or more of electrical, electromagnetic, magnetic, and passive/active seismic imaging techniques. Step 704 determines a number of physical aspects of the volume of rock from the images obtained in step 702. The physical aspects include, but are not limited to, magnetic susceptibility, velocity or density, and electrical conductivity.

Step 706 determines an area of serpentinization within the volume of rock. In one embodiment, step 706 combines the physical aspects of two or more of magnetic susceptibility, velocity or density, and electrical conductivity to determine areas of serpentinization.

Step 708 then directs hydrogen capturing equipment in accordance with the areas of serpentinization, such as the highest areas of serpentinization and/or areas of hydrogen concentration resulting from areas of serpentinization. For example, steerable well drilling equipment can be directed to areas with high concentration of hydrogen such as hydrogen concentration 124.

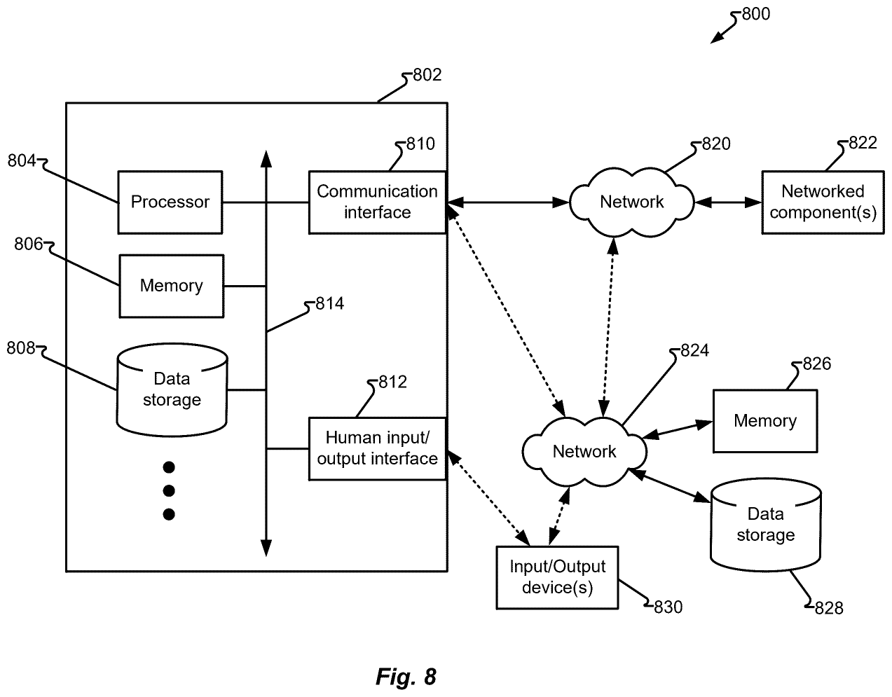

FIG. 8 depicts device 802 in system 800 in accordance with embodiments of the present disclosure. In one embodiment, device 802 comprising various components and connections to other components and/or systems and carries out operations, such as methods or portions thereof, described herein. In another embodiment, geophysical monitoring center 106 comprises, or is comprised by, device 802. The components are variously embodied and may comprise processor 804. The term “microprocessor” or, more simply, “processor,” refers exclusively to electronic hardware components comprising electrical circuitry with connections (e.g., pin-outs) to convey encoded electrical signals to and from the electrical circuitry. Processor 804 may comprise programmable logic functionality, such as determined, at least in part, from accessing machine-readable instructions maintained in a non-transitory data storage, which may be embodied as circuitry, on-chip read-only memory, computer memory 806, data storage 808, etc., that cause the processor 804 to perform the steps of the instructions. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814. In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize computer memory 806 and/or data storage 808 for the storage of accessible data, such as instructions, values, etc. Communication interface 810 facilitates communication with components, such as processor 804 via bus 814 with components not accessible via bus 814. Communication interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, speaker, microphone, still and/or video camera, etc. In another embodiment, communication interface 810 may comprise, or be comprised by, human input/output interface 812. Communication interface 810 may be configured to communicate directly with a networked component or configured to utilize one or more networks, such as network 820 and/or network 824.

Network 820 may be a wired network (e.g., Ethernet), wireless (e.g., WiFi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.).

Additionally or alternatively, one or more other networks may be utilized. For example, network 824 may represent a second network, which may facilitate communication with components utilized by device 802. For example, network 824 may be an internal network to a business entity or other organization, whereby components are trusted (or at least more so) than networked components 822, which may be connected to network 820 comprising a public network (e.g., Internet) that may not be as trusted.

Components attached to network 824 may include computer memory 826, data storage 828, input/output device(s) 830, and/or other components that may be accessible to processor 804. For example, computer memory 826 and/or data storage 828 may supplement or supplant computer memory 806 and/or data storage 808 entirely or for a particular task or purpose. As another example, computer memory 826 and/or data storage 828 may be an external data repository (e.g., server farm, array, “cloud,” etc.) and enable device 802, and/or other devices, to access data thereon. Similarly, input/output device(s) 830 may be accessed by processor 804 via human input/output interface 812 and/or via communication interface 810 either directly, via network 824, via network 820 alone (not shown), or via networks 824 and 820. Each of computer memory 806, data storage 808, computer memory 826, data storage 828 comprises a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 830 may be a router, a switch, a port, or other communication component such that a particular output of processor 804 enables (or disables) input/output device 830, which may be associated with network 820 and/or network 824, to allow (or disallow) communications between two or more nodes on network 820 and/or network 824. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing resource of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
imaging a volume of rock in a subsurface region;
obtaining measured data from imaging;
determining from the measured data at least two physical aspects comprising: (1) electrical conductivity; (2) magnetic susceptibility and magnetization; (3) seismic velocity and seismic density; and (4) micro-seismic event locations a volume of rock;
determining an area of serpentinization within the volume of rock comprising generating a model of the volume of rock by combining the at least two physical aspects; and
directing hydrogen capturing equipment to collect and extract hydrogen from at least one of the area of serpentinization or other areas with hydrogen accumulation.

2. The method of claim 1, wherein directing the hydrogen capturing equipment in accordance with the area of serpentinization further comprises:
identifying a feature in the volume of rock that concentrates hydrogen; and
directing the hydrogen capturing equipment to the feature.

3. The method of claim 1, further comprising identifying a fault structure in the area of serpentinization based on the model generated by combining the at least two physical aspects.

4. The method of claim 1, wherein generating the model further comprises generating a three-dimensional image of the volume of rock comprising the at least two physical aspects.

5. The method of claim 1, wherein the area of serpentinization is at least one of artificially stimulated or naturally occurring.

6. The method of claim 1, wherein imaging the volume of rock further comprises:
deploying a number of transmitters to transmit a corresponding number of signals through the volume of rock;
deploying a number of receivers to receive the number of signals;
activating at least some of the number of transmitters; and
receiving, at the number of receivers, at least a portion of the number of signals and converting the portion of the number of signals into image data.

7. The method of claim 6, wherein the number of transmitters and the number of receivers form at least one of a surface sensor array, a cross-well sensor array, and a combined surface-borehole sensor array.

8. The method of claim 1, identifying a fault structure or network of fractures that occur naturally or are produced artifactually in the area of serpentinization based on the model generated by combining the at least two physical aspects, the fault structure concentrating hydrogen, wherein:
directing the hydrogen capturing equipment in accordance with the area of serpentinization further comprises directing the hydrogen capturing equipment to the fault structure;
generating the model further comprises generating a three-dimensional image of the volume of rock comprising the at least two physical aspects; and
the area of serpentinization is at least one of artificially stimulated or naturally occurring;
imaging the volume of rock further comprises:
deploying a number of transmitters to transmit a corresponding number of signals through the volume of rock;
deploying a number of receivers to receive the number of signals;
activating the number of transmitters;
receiving, at the number of receivers, at least a portion of the number of signals and converting the portion of the number of signals into image data;
the number of transmitters and the number of receivers form at least one of a surface sensor array, a cross-well sensor array, and a combined surface-borehole sensor array; and
the number of receivers utilizes one or more of: ergodic sampling or regular sampling.

9. A system for extracting hydrogen from a volume of rock in a subsurface region, comprising:
a control system, the control system comprising at least one processor coupled to a computer memory having instructions stored therein that, when read by the at least one processor, cause the at least one processor to perform:
imaging a volume of rock in a subsurface region;
obtaining measured data for imaging;
determining from the measured data at least two physical aspects comprising: (1) electrical conductivity; (2) magnetic susceptibility and magnetization; (3) seismic velocity and seismic density; and (4) micro-seismic event locations a volume of rock;
determining an area of serpentinization within the volume of rock comprising generating a model of the volume of rock by combining the at least two physical aspects; and
directing hydrogen capturing equipment to collect and extract hydrogen from at least one of the area of serpentinization or other areas with hydrogen accumulation.

10. The system of claim 9, wherein directing the hydrogen capturing equipment in accordance with the area of serpentinization further comprises:
identifying a feature in the volume of rock that concentrates hydrogen; and
directing the hydrogen capturing equipment to the feature.

11. The system of claim 9, further comprising identifying a fault structure in the area of serpentinization based on the model generated by combining the at least two physical aspects.

12. The system of claim 9, wherein generating the model further comprises generating a three-dimensional image of the volume of rock comprising the at least two physical aspects.

13. The system of claim 9, wherein the area of serpentinization is at least one of artificially stimulated or naturally occurring.

14. The system of claim 9, wherein imaging the volume of rock further comprises:
deploying a number of transmitters to transmit a corresponding number of signals through the volume of rock;
deploying a number of receivers to receive the number of signals;
activating at least some of the number of transmitters; and
receiving, at the number of receivers, at least a portion of the number of signals and converting the portion of the number of signals into image data.

15. The system of claim 14, wherein the number of transmitters and the number of receivers form at least one of a surface sensor array, a cross-well sensor array, and a combined surface-borehole sensor array.

16. The system of claim 9, wherein directing the hydrogen capturing equipment comprises forming an injection well that extends from the surface to an area of the volume of rock comprising the area of serpentinization and wherein:
the control system is connected to one or more of a valve associated with the injection well;
the instructions further cause the at least one processor to regulate at least one of flow rate and pressure of a fluid, the fluid comprising water and a catalyst; and
the injection well injects the fluid into the area of the volume of rock comprising the area of serpentinization.

17. The system of claim 16, wherein the hydrogen capturing equipment comprises a hydrogen extraction well extending from the surface to the area of serpentinization.

18. The system of claim 16, wherein the hydrogen capturing equipment comprises a hydrogen extraction well located at a feature in the volume of rock that concentrates hydrogen produced in the area of serpentinization.

19. The system of claim 9, identifying a fault structure in the area of serpentinization based on the model generated by combining the at least two physical aspects, the fault structure concentrating hydrogen, wherein:
directing the hydrogen capturing equipment in accordance with the area of serpentinization further comprises directing the hydrogen capturing equipment to the fault structure;
generating the model further comprises generating a three-dimensional image of the volume of rock comprising the at least two physical aspects;
the area of serpentinization is at least one of artificially stimulated or naturally occurring;
imaging the volume of rock further comprises:
deploying a number of transmitters to transmit a corresponding number of signals through the volume of rock;
deploying a number of receivers to receive the number of signals;
activating the number of transmitters; and
receiving, at the number of receivers, at least a portion of the number of signals and converting the portion of the number of signals into image data;
the number of transmitters and the number of receivers form at least one of a surface sensor array, a cross-well sensor array, and a combined surface-borehole sensor array; and
the number of receivers utilizes one or more of: ergodic sampling or regular sampling.

20. A control system, comprising:
at least one processor coupled to a computer memory having instructions stored therein that, when read by the at least one processor, cause the at least one processor to perform:
imaging a volume of rock in a subsurface region;
obtaining measured data from the imaging;
determining from the measured data at least two physical aspects comprising: (1) electrical conductivity; (2) magnetic susceptibility and magnetization; (3) seismic velocity and seismic density; and (4) micro-seismic event locations a volume of rock;
determining an area of serpentinization within the volume of rock comprising generating a model of the volume of rock by combining the at least two physical aspects; and
directing hydrogen capturing equipment to collect and extract hydrogen from at least one of the area of serpentinization or other areas with hydrogen accumulation.
